(19) United States
(12) Patent Application Publication
(10) Pub. No.: US 2006/0259336 A1
(43) Pub. Date: Nov. 16, 2006

(54) METHODS AND SYSTEMS FOR MANAGING RISKS ASSOCIATED WITH A PROJECT

(75) Inventors: Meraj K. Anas, Marietta, GA (US); Joshua F. Hicks, Kennesaw, GA (US); Saumil N. Shah, Atlanta, GA (US); David Witsken, Alpharetta, GA (US); Joseph Dossie Barkley, Geneva, IL (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/908,528

(22) Filed: May 16, 2005

(51) Int. Cl. G06F 17/50

(52) U.S. Cl. 705/7

(57) ABSTRACT

Methods and systems for assessing risks associated with a project. The method includes building a tier 1 library and a tier 2 library. The tier 2 library includes project templates specific to a service/product offering or project type. Building the tier 1 and tier 2 libraries includes identifying project activities associated with a project. The building also includes identifying at least one potential failure associated with each of the project activities, associating project activities that are determined to be generic to all projects with the tier 1 library, and associating project activities that are determined not to be generic to all projects with each of the project templates in the tier 2 library. The method also includes generating a project file from the tier 1 and tier 2 libraries, and calculating a baseline risk score for each of the project activities in the project file.

### BACKGROUND OF THE INVENTION

Exemplary embodiments relate generally to risk management, and more particularly, to methods, systems, and computer program products for managing risks associated with a project.

Existing risk management tools provide the ability to assess the potential risks associated with a project. A risk refers a real or potential consequence resulting from the occurrence of an identified failure. The assessment processes typically involve documenting and ranking the potential risk by severity (e.g., how great of an issue is the risk if it were to happen), occurrence (how likely is it that the risk will happen), and detectability (capability of detecting the risk before it occurred). Each of these items is numerically ranked, resulting in a Baseline Priority Number, which serves as the numerical risk value. The ranking schemes of existing risk management tools are vague in that they do not factor in various elements that may be of equal importance to the overall risk assessment as the general categories of risk described above. Moreover, existing risk management tools do not enable a service provider (e.g., the entity implementing a project) to provide joint risk mitigation services to outside entities (such as entities for which the services are provided) such that the outside entities can collaborate in the effort to identify, rank and abate any known or potential risks, while protecting proprietary or private information.

What is needed, therefore, is means for providing risk management services that account for specific categories of risk, thereby providing more accuracy in the risk assessment process. Trending of risk over time would allow for monitoring of risk management efforts. What is also needed is a means for collaborative mitigation with external entities while maintaining the integrity of the sensitive or proprietary information of a provider entity implementing the risk management. Finally, a process and system are needed to leverage common risk items to similar yet separate risk management efforts.

### BRIEF DESCRIPTION OF THE INVENTION

Exemplary embodiments relate to methods and systems for evaluating risks associated with a project. The method includes building a tier 1 library and a tier 2 library. The tier 2 library includes project templates specific to a particular service offering, product offering, or project type. Building the tier 1 and tier 2 library includes identifying project activities associated with a project. The project is one of multiple projects for a service offering, product offering, or project type. The building also includes identifying at least one potential failure associated with each of the project activities, associating project activities that are determined to be generic to all projects with the tier 1 library, and associating project activities that are determined not to be generic to all projects with each of the project templates in the tier 2 library. The method also includes generating a project file from the tier 1 library and the tier 2 library, and calculating a baseline risk score for each of the project activities in the project file.

Systems for evaluating risks associated with a project include a processor implementing risk evaluation activities and a storage device in communication with the processor. The risk evaluation activities include building a tier 1 library and a tier 2 library. The tier 2 library includes project templates specific to a particular service offering, product offering, or project type. Building the tier 1 and tier 2 library includes identifying project activities associated with a project. The project is one of multiple projects for a service offering, product offering, or project type. The building also includes identifying at least one potential failure associated with each of the project activities, associating project activities that are determined to be generic to all projects with the tier 1 library, and associating project activities that are determined not to be generic to all projects with each of the project templates in the tier 2 library. The risk evaluation activities also include generating a project file from the tier 1 library and the tier 2 library, and calculating a baseline risk score for each of the project activities in the project file.

Other systems and methods according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the risk evaluation and management activities may be implemented in exemplary embodiments;

FIG. 2 is a flow diagram describing a process for building a tier 1 library and a tier 2 library in exemplary embodiments;

FIG. 3A-3B is a flow diagram describing a process for implementing risk evaluation and management activities in exemplary embodiments;

FIG. 4 is a sample portion of a new project file displaying risk analysis data generated via the risk management system in exemplary embodiments;

FIG. 5 is a sample portion of a new project file displaying a tier 2 library generated and manipulated by the risk management system in exemplary embodiments; and

FIGS. 6A-6B are graphical representations of risk scores determined over a selected time period in exemplary embodiments.

### DETAILED DESCRIPTION OF THE INVENTION

Exemplary embodiments include a method, system, and computer program product for managing risks associated with a project. Risk evaluation and management services are provided that account for technical, schedule, and financial risks associated with project activities when assessing risks identified for a given project. Automatic filtering of information is enabled by classifying risk elements as external or internal, such that sensitive or propriety information is protected and joint risk mitigation efforts may be provided by sharing the non-sensitive information with outside entities. Trending capabilities are established to allow for graphical display of risk exposure over time. A “learning library” is also provided as a repository for project information that is re-usable and editable over time.

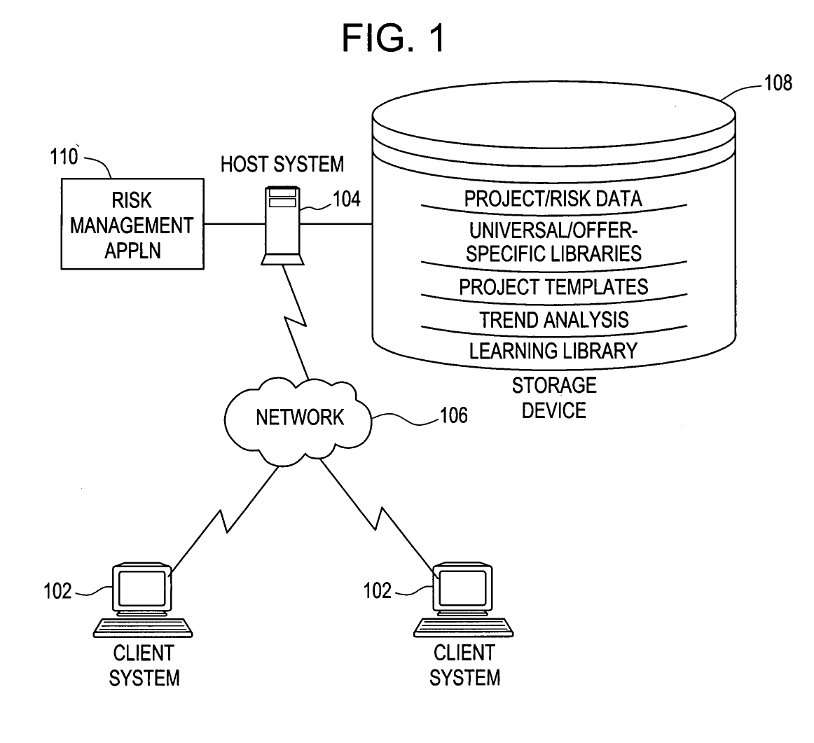

Turning now to FIG. 1, a system upon which the risk evaluation and management activities may be implemented in exemplary embodiments will now be described. The risk evaluation and management services are provided by a provider entity for internal use as well as on behalf of its customers, outside entities (also referred to herein as recipients) with which the risk evaluation and management services may be conducted. For purposes of illustration, but not limiting of the invention, the provider entity is a provider of power plant services and its customers are power plant companies.

The system depicted in FIG. 1 includes one or more client systems 102 through which users at one or more geographic locations may contact the host system 104. The host system 104 executes computer instructions for implementing risk evaluation and management activities and the client systems 102 are coupled to the host system 104 via a network 106. Each client system 102 may be implemented using a general-purpose computer executing a computer program for carrying out the processes described herein. The client systems 102 may be personal computers (e.g., a lap top, a personal digital assistant) or host attached terminals. If the client systems 102 are personal computers, the processing described herein may be shared by a client system 102 and the host system 104 (e.g., by providing an applet to the client system 102). Client systems 102 may be operated by project team members or managers of the provider entity.

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A client system 102 may be coupled to the host system through multiple networks (e.g., intranet and Internet) so that not all client systems 102 are coupled to the host system 104 through the same network. One or more of the client systems 102 and the host system 104 may be connected to the network 106 in a wireless fashion. In one embodiment, the network is an intranet and one or more client systems 102 execute a user interface application (e.g. a web browser) to contact the host system 104 through the network 106. In another exemplary embodiment, the client system 102 is connected directly (i.e., not through the network 106) to the host system 104 and the host system 104 is connected directly to or contains the storage device 108.

The storage device 108 includes project and risk data associated with service offerings and/or product offerings provided by the provider entity. A service offering refers to activities conducted by the provider entity on behalf of its clients, customers, or other third-party entities. Service offering information stored in storage device 108 may be categorized and/or defined by the nature of the service provided (e.g., maintenance, installation, refurbishments, etc.), which in turn may be classified into sub-offerings (e.g., maintenance performed on mechanical equipment, vehicles, computer devices, etc.). Product offerings may include tangible items provided to clients, customers, or other third-party entities (e.g., via sale, lease, licensing, etc.).

The projects may be defined by project activities conducted in furtherance of the project and may be further defined by project phases or tollgates. The storage device 108 also stores master templates and related tier 1 libraries (e.g., universal risk libraries), project templates and related tier 2 libraries (e.g., offering-specific risk libraries), results of trend analyses, and a learning library. Tier 1 and tier 2 libraries will be described herein with respect to universal risk libraries and offering-specific risk libraries, respectively, for purposes of illustration. Universal risk libraries store data relating to project activities that are determined to be generic to all projects associated with product and/or service offerings of the provider entity. Conversely, offering-specific libraries store data specific to a given project type, service offering, and/or product offering. These libraries are described further herein.

It is understood that the storage device 108 may be implemented using memory contained in the host system 104 or it may be a separate physical device. The storage device 108 is logically addressable as a consolidated data source across a distributed environment that includes a network 106. Information stored in the storage device 108 may be retrieved and manipulated via the host system 104 and may be viewed via the client system 102.

In exemplary embodiments of the present invention, the host system 104 operates as a database server and coordinates access to application data including data stored on the storage device 108.

The host system 104 depicted in FIG. 1 may be implemented using one or more servers operating in response to a computer program stored in a storage medium accessible by the server. The host system 104 may operate as a network server (e.g., a web server) to communicate with the client systems 102. The host system 104 handles sending and receiving information to and from the client systems 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs (e.g., a risk management application 110) for implementing the risk management activities described herein. Processing may be shared by the client systems 102 and the host system 104 by providing an application (e.g., java applet) to the client systems 102. Alternatively, the client systems 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

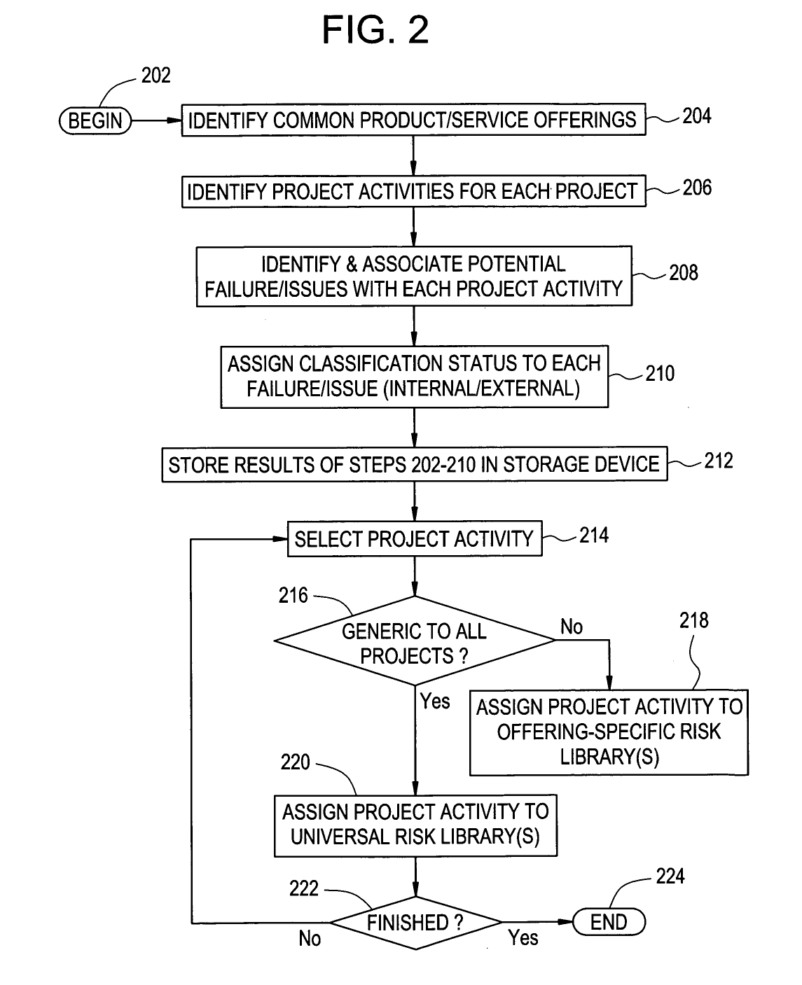

Turning now to FIG. 2, a flow diagram for building universal (tier 1) and offering-specific (tier 2) risk libraries for use in implementing the risk evaluation and management activities will now be described. At step 202, the process begins whereby all projects associated with the provider entity's offerings are identified at step 204 via, e.g., the host system 104 of FIG. 1. At step 206, project activities associated with these projects are identified. A project activity includes any action or process that is implemented in furtherance of a project. There are typically multiple activities for a given project. As indicated above, projects may be further defined by project phases or disciplines as described further herein.

For each project activity, a potential failure or issue is identified at step 208. A failure may relate to a real or potential negative consequence of performing a given project activity. For example, suppose a project activity involves the operation of a crane. The project phase or discipline may be during the installation phase of the project. For example, potential failure or issue in operating the crane may be a breakdown of the crane's lifting mechanism or damage caused by the environment, which could result in injury, damage to equipment, repair costs, and/or project delay. There may be multiple potential failures and potential causes identified for a given project activity. At step 210, a classification status is assigned to, or otherwise associated with, each potential failure or issue. The classification status is assigned as either of internal or external. An internal classification status is assigned to, or otherwise associated with, items that are considered proprietary, sensitive, or are otherwise protectable by the provider entity, such that disclosure to outside entities is restricted. An external classification, by contrast, is assigned to items that may be shared with entities outside of the provider entity.

At step 212, the results of steps 202-210 are stored in storage device 108 for further processing as described herein. Steps 214-224 enable the provider entity to distinguish project activities that are generic or common to all projects from project activities that are specific to a given project type, product offering, and/or service offering. In step 214, a project activity is selected from storage device 108. At step 216, it is determined whether the project activity is generic to all projects provided by the provider entity. If not, the project activity is considered to be specific to a given project type, product offering, and/or service offering. In this event, the project activity and related risk information are assigned to an offering-specific risk library at step 218 and stored in storage device 108.

If, on the other hand, the project activity is considered to be generic to all projects offered by the provider entity at step 216, the project activity and related risk information are assigned to the universal risk library at step 220 and stored in storage device 108. At step 222, it is determined whether all project activities have been processed as one of generic or offering-specific at step 222. If so, the libraries are complete and the process ends at step 224. Otherwise, the process returns to step 214, whereby another project activity is selected. By building a universal risk library, project managers for a variety of different projects are able to use and reuse these master templates without recreating commonly occurring information elements. Likewise, offering-specific risk libraries enable project managers to efficiently reuse project activities and risk information for new projects of a certain product or service offering/project type without having to recreate offering-specific information elements. In addition, universal and offering-specific risk libraries are appended upon completion of individual projects, and a review of risk items from a project that are not already in the library is performed by a specified library owner to identify items that should be incorporated into the library.

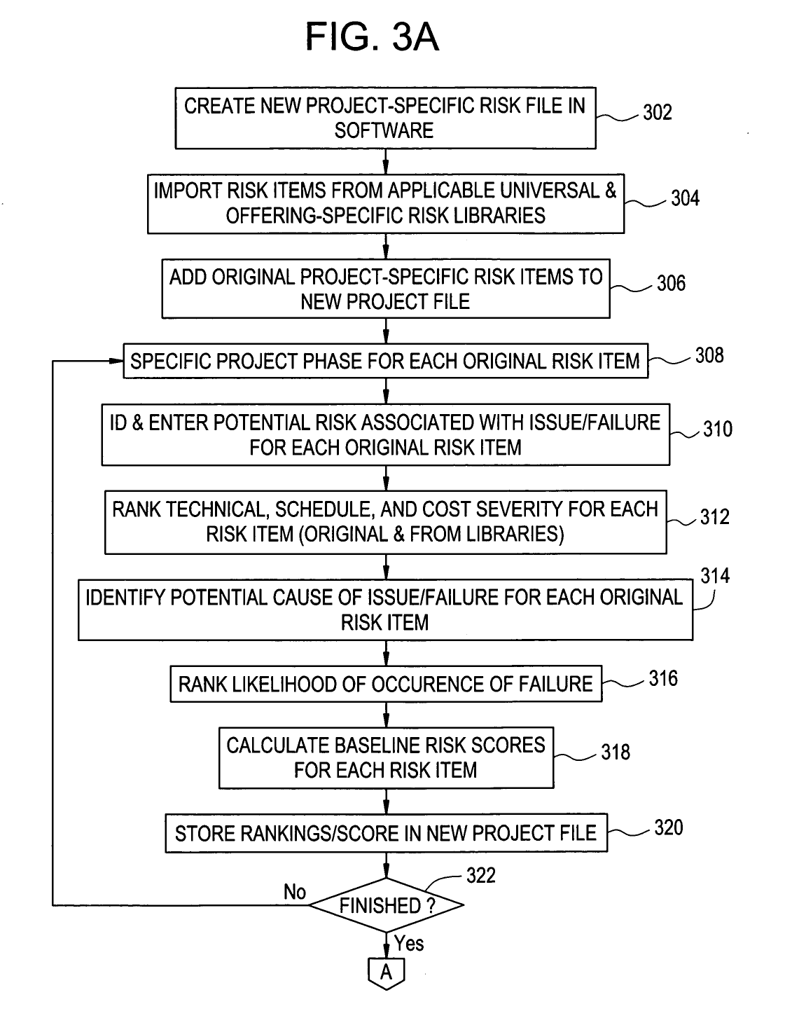

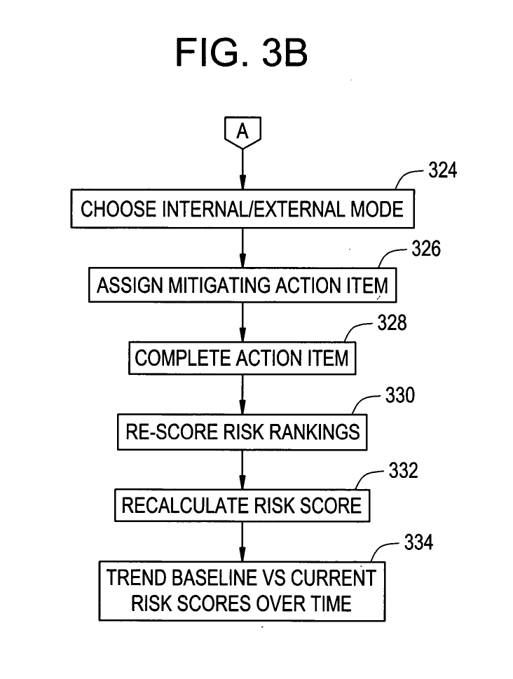

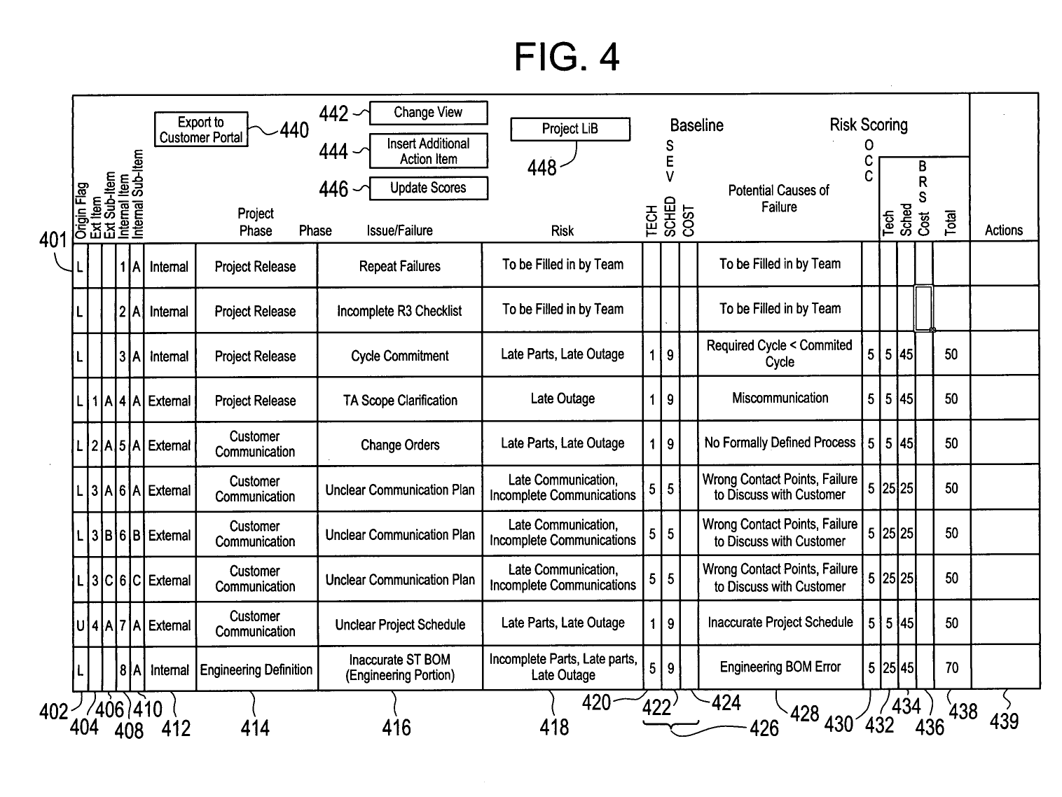

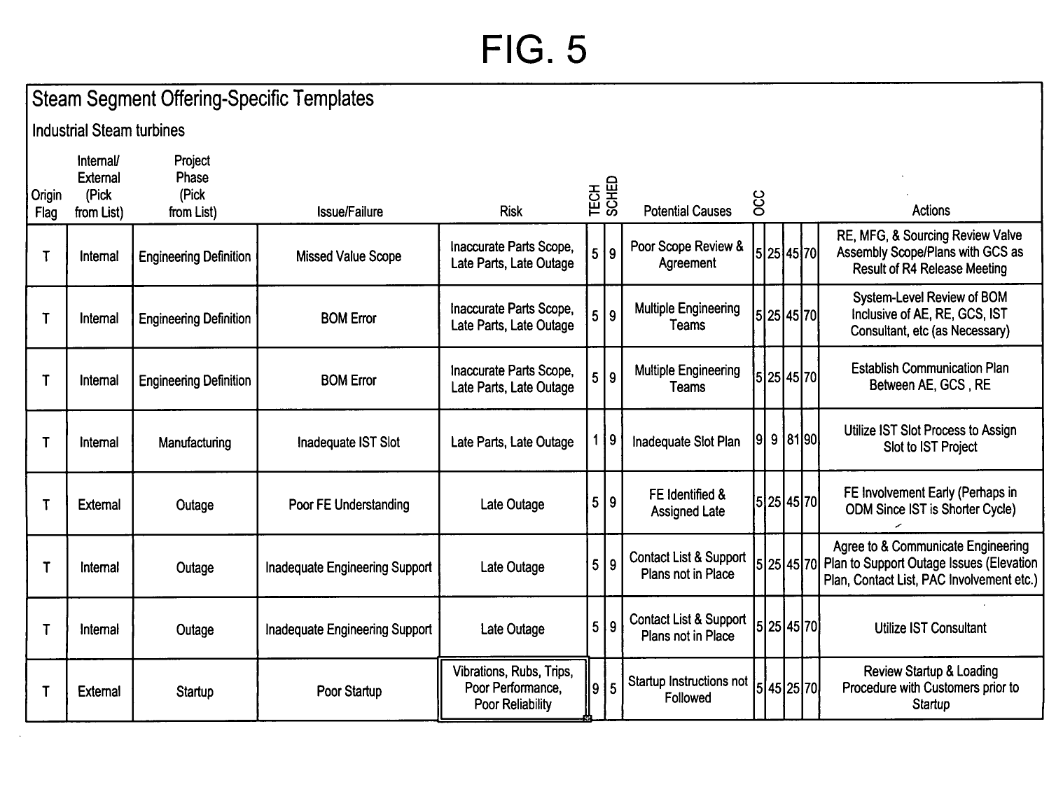

Turning now to FIG. 3A-3B, a process for implementing risk evaluation and management activities utilizing both risk libraries and original user inputs will now be described. A project manager or project team member with authorization creates a new project-specific risk file via risk management application 110 at step 302. This copy is referred to herein as a new project file. A sample new project file displaying typical format of risk data is shown in FIG. 4. At step 304, risk items from universal and offering-specific risk libraries are imported into the new project file. Each row presented in a new project file (e.g., row 401 of FIG. 4) corresponds to a risk item. The type of offering-specific risk library selected will depend upon the nature of the project being implemented, as each offering-specific library is specific to a given project type, product offering, and/or service offering. A listing of project libraries is available to the creator of the project file via the risk management application 110 (e.g., toolbar option 448, menu of FIG. 4). Once a risk library is accessed, the project manager may import risk items from the library. Risk items originating from risk libraries already include data for Internal/External Coding (column 412), Project Phase (column 414), Issue/Failure (column 416), Risk (column 418), Potential Cause of Failure (column 428), and elemental rankings. These imported risk items are coded as originating from a library as indicated in column 402. A sample new project file displaying risk data that includes project-specific activities is shown in FIG. 5.

Once all desired risk items are imported into the new project file from risk libraries, the project manager (possibly with team input) may also manually input project-specific risk items not originating from a library at step 306. For these original risk items, which are coded by the risk management application 110 as originating from the user at one of client systems 102 (e.g., ‘U’ in column 402 of FIG. 4), the project manager is prompted to select one of the project disciplines listed in the new project file at step 308. This may be accomplished by selecting a project phase from column 414, upon which a drop down list of related project activities is provided (not shown) For example, the issue related to crane operation may correspond with a project phase or discipline of outage or installation, as selected from the drop down list in column 414. As shown in FIG. 4, a column 416 displays an issue/failure associated with the project activity (received from step 208 of FIG. 2). The project manager is prompted to enter a potential risk associated with the failure/issue provided for the project activity in column 418 at step 310. At step 312, the project manager is prompted to rank each risk according to three risk categories. This step is referred to as a severity ranking 326. A technical risk is entered in column 420, a schedule risk is entered in column 422, and a cost risk is entered in column 424. A technical risk refers to risks involving quality of service. Technical risks adversely impact the availability, reliability, safety, or quality of the provided product or service. For example, a risk item resulting in poor product reliability would be scored as having high technical risk. A schedule risk involves timeliness or capability of delivering a product or service per schedule. A realized schedule risk would result in departure from on-time completion of a project task or deliverable relative to the project schedule. A cost risk involves expenses incurred in the event that the risk is realized. A realized cost risk would result in unexpected, un-budgeted, expenses in order to recover from, or mitigate against, the failure/issue. The ranking values include 1, 5 and 9, with 1 indicating a low risk, 5 indicating a moderate risk, and 9 indicating a high risk. By providing only three ranking values, a project manager or individual assessing the risks are not burdened with the subjectivity involved in assessing the severity of a risk including relativity of the severity between or among multiple risks as would otherwise be encountered using a ranking system of, e.g., 1 through 9 in increments of 1.

At step 314, the project manager is prompted to identify and enter a potential cause of failure associated with the project activity in column 428. At step 316, the project manager is then prompted to evaluate and rank the likelihood that the failure will occur depending upon the potential cause identified in step 314. This ranking is entered in column 430. A baseline risk score is calculated for the project activity using the information provided in steps 312 and 316. The baseline risk score may be calculated as described herein. Each of the values in columns 420-424 is multiplied by the value in column 430. The results of each multiplication are entered in columns 432-436, respectively. The values in columns 432-436 reflect the severity score for each risk category having factored in its likelihood of occurrence. The values in columns 432-436 are added together and entered into column 438. This value is the baseline or unmitigated risk score. As described above, only three numerical values are used in ranking the three risk categories, thereby limiting the range of possible baseline risk score values. The scores calculated and entered in columns 432-438 may be color-coded by severity level so that an individual reviewing the new project file can quickly determine and prioritize the project activities that require immediate attention.

The rankings/score are stored in the new project file at step 320. At step 322, it is determined whether all project activities listed in the new project file have been processed. If not, the process returns to step 308 whereby another project activity is selected. Otherwise, once all project activities have been evaluated and processed, the process proceeds to FIG. 3B.

Steps 324-334 enable a project manager or authorized individual to identify any mitigating actions that may be performed in order to minimize or negate the risks and recalculate the severity rankings and current risk score to represent the modified or minimized risk associated with performing the mitigating action. Steps 324-334 further enable a project manager or other authorized individual to evaluate the efficacy of completed mitigating actions, their effect upon the project activity risks in terms of the revised current risk scores, and to save this information in a learning library that can be used by others.

The process of periodically reviewing and updating action items, completion dates, and revised risk rankings can be performed with a solely internal or combined internal/external team. For example, a project performed on behalf of a customer of the provider entity may involve information that, if shared with the customer, is useful in mitigating mutual risks identified in the project file. Suppose a customer is a power plant and the provider entity is upgrading the customer's system. The customer may benefit from participating in the risk identification and scoring process such that the customer can take pre-emptive action that would enable avoidance of potential delays, power outages, additional costs, etc. Because the project activities and related failures/issues are classified as being either external or internal, the provider entity can quickly select an external view of the new project file at step 324 via option 442 and share the external information with the customer via option 440. The risk management application 110 provides a numbering scheme that enables an ordered listing of project activities and sub-activities that distinguishes between internal and external classifications. For example, columns 404 and 406 display an alphanumeric numbering system for externally classified information, while columns 408 and 410 display an alphanumeric numbering system for internally classified information.

At step 326, the project manager enters a mitigating action in column 439. Once the mitigating action has been completed at step 328, the project manager enters new severity rankings in columns 420-424 at step 330. The new severity rankings are determined by the extent to which a risk has been minimized by performing the mitigating action. The current risk score is then recalculated using this new information at step 332 and the results are saved to the new project file in column 438. The project activities for which a mitigating action has been entered are flagged by the risk management application (e.g., ‘U’ for user-provided) and stored in the new project file. All other project activities are flagged as ‘L’ (as originating from the master or project library). The flag assigned is displayed in column 402. By flagging these entries, individuals that subsequently access a project file can quickly distinguish the user-provided entries from the template-originated entries. These individuals may then choose to keep the new entries when working on a new project or eliminate them as desired. This capability provides the provider entity with a learning library that may be saved and reused over time.

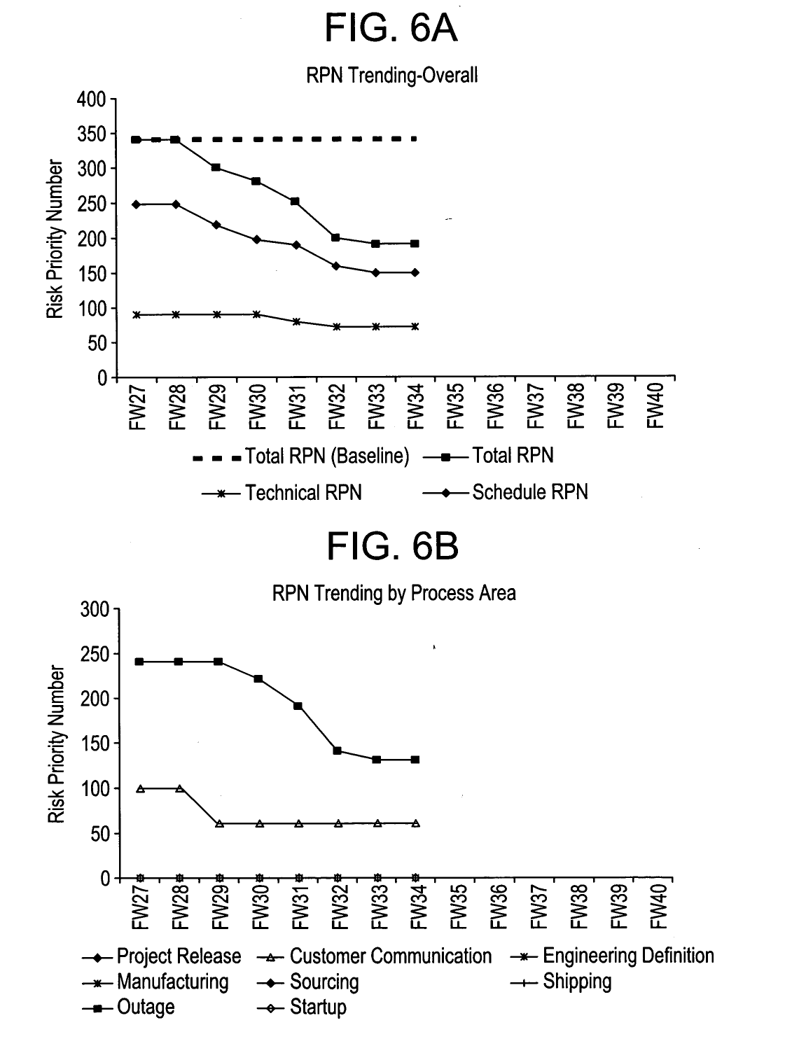

Additionally a record of baseline and current risk scores can be accumulated over the course of the process with the trend analysis capabilities. For any given time period of an ongoing project, the ranking and scoring data may be saved and updated as mitigating actions are taken and the scores are changed. The risk management application 110 enables a project manager or authorized individual to view risk information for a given time period and review the data for identifying any trends or patterns at step 334. The project manager selects the time period desired. A specific project is selected for which the analysis is desired. The project manager identifies the format in which to receive the information (i.e., an information request). The risk management application 110 provides graphical data that is presented by severity ranking (illustrated in FIG. 6A) or by project phase/segment (illustrated in FIG. 6B). The risk management application 110 generates a chart in accordance with the project manager's selection and presents the chart.

As indicated above, the risk management services account for technical, schedule, and financial risks associated with project activities when assessing risks identified for a given project. Automatic filtering of information classified as internal or external enables a provider entity to share non-sensitive information and provide joint risk mitigation efforts. A learning library is also provided as a repository for project information that is re-usable over time.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to enable the efficient detection of stress corrosion and cracking of pipelines.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for assessing risks associated with a project, comprising:
building a tier 1 library and a tier 2 library, the tier 2 library including project templates specific to at least one of a particular service offering, product offering, and project type, the building comprising:
identifying project activities associated with a project, the project comprising the at least one of a service offering, product offering, and project type;
identifying at least one potential failure associated with each of the project activities;
associating project activities that are determined to be generic to all projects with the tier 1 library; and
associating project activities that are determined not to be generic to all projects with each of the project templates in the tier 2 library;
generating a project file from the tier 1 library and the tier 2 library, the generating performed in response to a new project; and
calculating a baseline risk score for each of the project activities in the project file.

2. The method of claim 1, wherein the generating a project file includes:
entering the project activities associated with the tier 1 library; and
entering selected project activities from the tier 2 library.

3. The method of claim 1, wherein the calculating a baseline risk score further comprises:
for each project activity in the project file:
receiving a potential risk associated with the potential failure;
receiving a severity ranking for the potential risk, the severity ranking including a technical risk value, a schedule risk value, and a cost risk value;
receiving a likelihood of occurrence rank for the potential risk,
the likelihood of occurrence rank based upon a potential cause of the potential failure;
calculating the baseline risk score using the severity ranking and the likelihood of occurrence rank; and
storing the severity ranking, the likelihood of occurrence rank, and the baseline risk score in the project file.

4. The method of claim 3, wherein:
the technical risk includes risks involving quality of service, the technical risk determined to adversely impact the availability, reliability, safety, or quality of the provided product or service;
the schedule risk includes risks involving timeliness or capability of delivering a product or service; wherein a realized schedule risk results in departure from on-time completion of a project task or deliverable relative to the project schedule; and
the cost risk includes risks involving expenses associated with the failure effects if a risk were to be realized or expenses incurred in removing a risk; wherein a realized cost risk results in unexpected, un-budgeted expenses in order to recover from or to mitigate against the failure or issue.

5. The method of claim 4, wherein the baseline risk score is derived by the taking the sum of the products of each of the technical risk, schedule risk, and cost risk and corresponding likelihood of occurrence rank.

6. The method of claim 4, further comprising:
receiving at least one mitigating action to be applied to a risk identified in the project file, the mitigating action operable for reducing negative effects of the risk;
receiving either of an other severity ranking for at least one of the technical risk, schedule risk, and cost risk, or an other likelihood of occurrence ranking, the other severity or the other likelihood of occurrence rank determined in accordance with an outcome associated with performance of the mitigating action;
re-calculating the baseline risk score for the risk in response to the other severity ranking or the other likelihood of occurrence rank, the re-calculating resulting in a current risk score; and
storing at least one mitigating action and the current risk score in the project file along with the mitigating action.

7. The method of claim 6, further comprising providing trend analysis of the risks identified in the project file, the trend analysis including generating graphical representations of risk scores over a selected time period, the graphical representations including at least one of:
a risk score chart including baseline and current risk scores and severity rankings broken down by category over a time period; and
a project phase chart including baseline and current risk scores broken down by project phases associated with the risks.

8. The method of claim 1, further comprising developing a learning library, including:
updating the tier 1 and tier 2 libraries with risk items that are determined to be leveragable for other projects, regardless of service offering, product offering, or project type, to include a new mitigating action and corresponding severity ranking and baseline risk score, the new mitigating action received from the project file, and the new mitigating action added to the project file by a project team member.

9. The method of claim 1, further comprising grouping the project activities into project segments, each of the project segments corresponding to a phase of the project.

10. The method of claim 1, wherein the project is performed by a provider entity on behalf of a recipient, the method further comprising providing joint risk mitigation services to the recipient, the joint risk mitigation services including:
assigning a classification status to each of the risks, the classification status comprising one of internal and external, wherein risks assigned an internal classification status are protectable by the provider entity;
storing results of the assigning of a classification status in the tier 1 library and the tier 2 library;
searching the project file for risks associated with a project that are assigned an external classification status; and
collaborating with the recipient on only information relating to the risks assigned the external classification status jointly assessing baseline and current risk scores and mitigating actions.

11. A system for assessing risks associated with a project, comprising:
a processor implementing risk evaluation and management activities; and
a storage device in communication with the processor, the risk evaluation and management activities including:
building a tier 1 library and a tier 2 library, the tier 2 library including project templates specific to at least one of a particular service offering, product offering, and project type, the building comprising:
identifying project activities associated with a project, the project comprising the at least one of a service offering, product offering, and project type;
identifying at least one potential failure associated with each of the project activities;
associating project activities that are determined to be generic to all projects with the tier 1 library; and
associating project activities that are determined not to be generic to all projects with each of the project templates in the tier 2 library;
generating a project file from the tier 1 library and the tier 2 library, the generating performed in response to a new project; and
calculating a baseline risk score for each of the project activities in the project file.

12. The system of claim 11, wherein the generating a project file includes:
entering the project activities associated with the tier 1 library; and
entering selected project activities from the tier 2 library.

13. The system of claim 11, wherein the calculating a baseline risk score further comprises:
for each project activity in the project file:
receiving a potential risk associated with the potential failure;
receiving a severity ranking for the potential risk, the severity ranking including a technical risk value, a schedule risk value, and a cost risk value;
receiving a likelihood of occurrence rank for the potential risk, the likelihood of occurrence rank based upon a potential cause of the potential failure;
calculating the baseline risk score using the severity ranking and the likelihood of occurrence rank; and
storing the severity ranking, the likelihood of occurrence rank, and the baseline risk score in the project file.

14. The system of claim 13, wherein:
the technical risk includes risks involving quality of service, the technical risk determined to adversely impact the availability, reliability, safety, or quality of the provided product or service;
the schedule risk includes risks involving timeliness or capability of delivering a product or service; wherein a realized schedule risk results in departure from on-time completion of a project task or deliverable relative to the project schedule; and
the cost risk includes risks involving expenses associated with the failure effects if a risk were to be realized or expenses incurred in removing a risk; wherein a realized cost risk results in unexpected, un-budgeted expenses in order to recover from or to mitigate against the failure or issue.

15. The system of claim 14, wherein the baseline risk score is derived by the taking the sum of the products of each of the technical risk, schedule risk, and cost risk and corresponding likelihood of occurrence rank.

16. The system of claim 14, wherein the risk evaluation and management activities further include:
receiving at least one mitigating action to be applied to a risk identified in the project file, the mitigating action operable for reducing negative effects of the risk;
receiving either of an other severity ranking for at least one of the technical risk, schedule risk, and cost risk, or an other likelihood of occurrence ranking, the other severity or the other likelihood of occurrence rank determined in accordance with an outcome associated with performance of the mitigating action;
re-calculating the baseline risk score for the risk in response to the other severity ranking or the other likelihood of occurrence rank, the re-calculating resulting in a current risk score; and
storing at least one mitigating action and the current risk score in the project file along with the mitigating action.

17. The system of claim 16, wherein the risk evaluation and management activities further include providing trend analysis of the risks identified in the project file, the trend analysis including generating graphical representations of risk scores over a selected time period, the graphical representations including at least one of:
a risk score chart including baseline and current risk scores and severity rankings broken down by category over a time period; and
a project phase chart including baseline and current risk scores broken down by project phases associated with the risks.

18. The system of claim 11, wherein the risk evaluation and management activites further include developing a learning library, the developing including:
updating the tier 1 and tier 2 libraries with risk items that are determined to be leveragable for other projects, regardless of service offering, product offering, or project type, to include a new mitigating action and corresponding severity ranking and baseline risk score, the new mitigating action received from the project file, and the new mitigating action added to the project file by a project team member.

19. The system of claim 11, wherein the risk evaluation and management activities further include grouping the project activities into project segments, each of the project segments corresponding to a phase of the project.

20. The system of claim 11, further comprising a communications link to a client system, wherein the project is performed by a provider entity on behalf of a recipient associated with the client system, the risk evaluation and management activities further comprising providing joint risk mitigation services to the recipient at the client system, the joint risk mitigation services including:
assigning a classification status to each of the risks, the classification status comprising one of internal and external, wherein risks assigned an internal classification status are protectable by the provider entity;
storing results of the assigning of a classification status in the tier 1 library and the tier 2 library;
searching the project file for risks associated with a project that are assigned an external classification status; and
collaborating with the recipient on only information relating to the risks assigned the external classification status jointly assessing baseline and current risk scores and mitigating actions.
